(19) United States
(12) Patent Application Publication
(10) Pub. No.: US 2020/0104794 A1
(43) Pub. Date: Apr. 2, 2020

(54) TEMPLATE BASED TOOL

(71) Applicant: Frederick Trisjono, San Jose, CA (US)

(72) Inventor: Frederick Trisjono, San Jose, CA (US)

(21) Appl. No.: 16/297,489

(22) Filed: Mar. 8, 2019

Related U.S. Application Data
(60) Provisional application No. 62/739,775, filed on Oct. 1, 2018.

(51) Int. Cl. G06Q 10/10; G06Q 30/00

(52) U.S. Cl. CPC G06Q 10/10; G06F 3/0484; G06Q 30/01

(57) ABSTRACT

A personalized template-based system has a database that includes a user table. The user table assigns a weight to a user. The weight indicates whether the user is a client, an agent or an agency. A web application program interface (API) that includes a login application implementation that upon login by a user returns a token to the user that identifies the user, and includes an API implementation block used to obtain information from the database. Template tools utilize the token when the user obtains the information from the database. A learn template is used to access learning information from the database. The learning information is available from the interface to the user depending upon the weight assigned to the user. A connect template allows the user to communicate with other users. An act template provides forms through which the user can perform actions.

### BACKGROUND

Customer relationship management (CRM) applications address a wide array of needs in customer-related activities. CRM uses a combination of methodologies and software systems that companies can use to build relationships with clients. CRM applications currently on the market tend to target large-scale entities and provide enterprise solutions with many solutions.

### BRIEF DESCRIPTION OF THE DRAWINGS

FIG. 1 illustrates an agency that includes agents and clients, in accordance with an embodiment.

FIG. 2 is a simplified block diagram that shows an example architecture used when implementing relationship management between the agency, agents and clients shown in FIG. 1, in accordance with an implementation.

FIG. 3 is a simplified diagram illustrating different access and usage levels for a user that is an agency, an agent or a client, in accordance with an implementation.

FIG. 4 is a simplified diagram illustrating selection of templates and operations by a user that is an agency, an agent or a client, in accordance with an implementation.

FIG. 5 is a simplified diagram illustrating selection of topics and media by a user that is an agency, an agent or a client, in accordance with an implementation.

FIG. 6 is a simplified diagram illustrating selection of connections by a user that is an agency, an agent or a client, in accordance with an implementation.

FIG. 7 is a simplified diagram illustrating selection of actions by a user that is an agency, an agent or a client, in accordance with an implementation.

FIG. 8 illustrates use of ledger weights to distinguish accounts, objects and functions for an agency, an agent or a client, in accordance with an implementation.

FIG. 9 illustrates use of ledger weights to distinguish accounts, objects and functions for an agency, an agent or a client, in accordance with an implementation.

FIG. 10 is a simplified block diagram that illustrates interactions between a web browser a web server, web API components and a database when implementing connections between the agency, agents and clients, in accordance with an implementation.

### DETAILED DESCRIPTION

A template-based tool is used to help an connect a client, an agent, and an agency in education, communication, consulting, recruiting, marketing, and sales activities. The template-based tool implements personalization and targeted solutions. The personalization covers content delivery, interaction mechanism, and data exchanges between users. The template-based tool utilizes customizable templates that reduce the complexity of implementation and optimize scalability.

The template-based tool is deployed in mobile devices, web application and personal computer software. For example, the template-based tool can be applied in the financial industry. For example, when a client that can benefit from financial education, an agent can help the client with the knowledge as well as offerings. An agency can support the agent to garner and develop opportunities and to recruit more clients or agents. The template-based tool offers a set of tools to create the personalized engagement as well as personalized content. The template-based tool also provides relevant tools to track, plan and execute toward goals. To personalize, the template-based tool tracks user characteristics. User characteristics include, for example user type, an origin of how a user is introduced to the template-based tool, a level of acquisition or subscription, user inputs and the previous states of action.

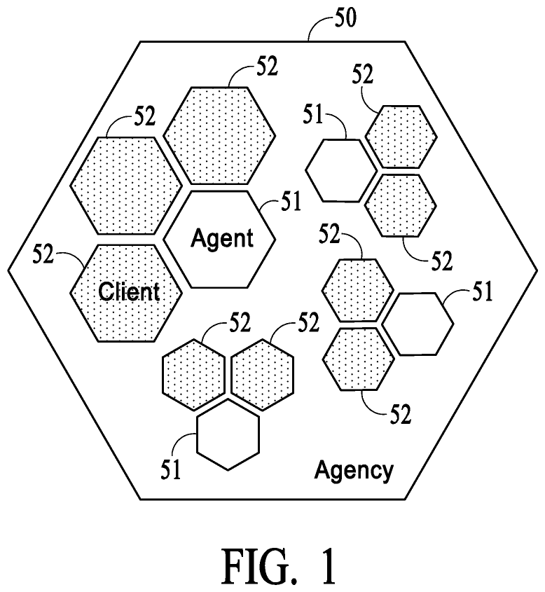

FIG. 1 shows an agency 50 that includes agents 51 and clients 52. An agent can connect with multiple clients and other agents that are embodied within agency 50. As illustrated, agency 50 can have multiple agents 51. Each agent can have multiple clients 52. Content developed within an agency 50 can be shared with all agents 51 and clients 52. The template-based tool maximizes the effectiveness of interactions between agency 50, agents 51, and clients 52. For example, the template-based tool stores information from each interaction between agency 50, agents 51, and clients 52 for historical data.

The template-based tool allows an agent to send personalized content to a client and vice versa. For example, the personalization is based on user characteristic. For example, an agent can send a targeted message to a client based on the client's age, gender, state of residency, goals, and all other parameters that are collected during referral and registration. A user can utilize a referral tool from the template-based tool to notify another potential user. Upon taking on a referral and after seeing a value proposition delivered by the template-based tool, a potential user may register to become a user. The process and data from referral to registration is recorded as a transaction ledger that is used by the template-based tool to establish future personalization for involved users.

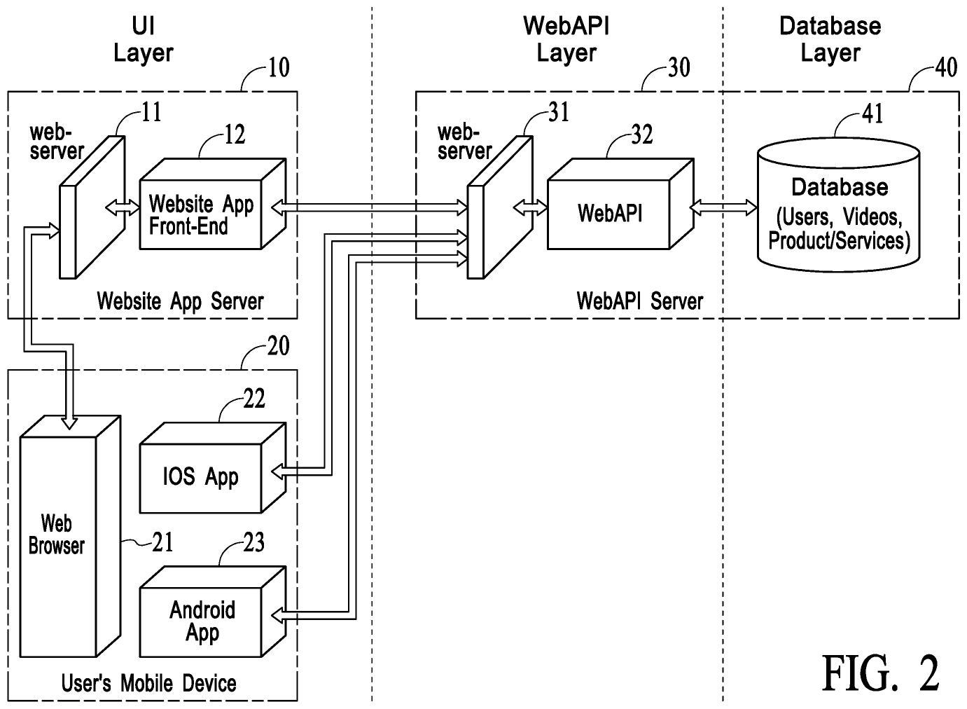

FIG. 2 is a simplified block diagram that shows an example architecture used when implementing relationship management between the agency, agents and clients shown in FIG. 1. For example, a user's mobile device includes a web browser 21 and an iOS App 22 or an Android App, depending on the operating system used by the mobile device.

A user interface (UI) layer 10 of a website app server includes a web-server 11 and a website app front end 12. A web application programming interface (Web API) layer 30 of the website app server includes a web server 31 and a Web API 32. A database layer 40 of the web app server includes a database 41 in which is stored information about users, videos, products and services.

The template-based tool connects a user to an agent and an agency through presentations, messages, and analytics delivered by web and mobile applications. For example, as illustrated by FIG. 2, the template-based tool is implemented across multiple technologies that include mobile-device applications, web applications and personal computer applications.

For example, personalization is achieved by recording an origin of how a user is introduced to the template-based tool and by recording the device identification within database 41, shown in FIG. 2. Such identification obviates the necessity to store cookies and so on for identification purposes. As a user uses the template-based tool and sees value, the user is able to use the template-based tool feature to invite another user. Key information of the inviter and the invitee are recorded as a unique ledger within database 41. When the invitee starts to use the template-based tool, a link between inviter and invitee is confirmed in the ledger of that transaction by the template-based tool. Upon further usage of the template-based tool, invitee's information will be stored for personalization. For example, the personalization covers on how the template-based tool presents itself and how others will interact with the invitees with the communicated contents or messages. For example, an agent and agency fit as the inviter's role and clients as invitees. A client can also be an inviter and when that occurs the ledger in the template-based tool will record accordingly. The personalization also covers the different level on how a user may utilize the template-based tool.

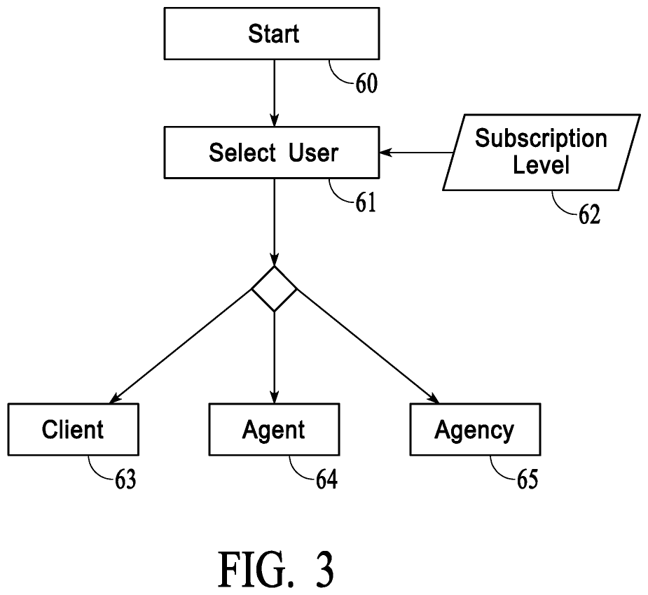

FIG. 3 is a simplified diagram illustrating different access and usage levels for a user that is an agency, an agent or a client. In a block 60, a user accesses the template-based tool. In a block 61, the user identification is selected. A subscription level 62 is accessed to determine whether the user is identified as a client 63, an agent 64 or an agency 65.

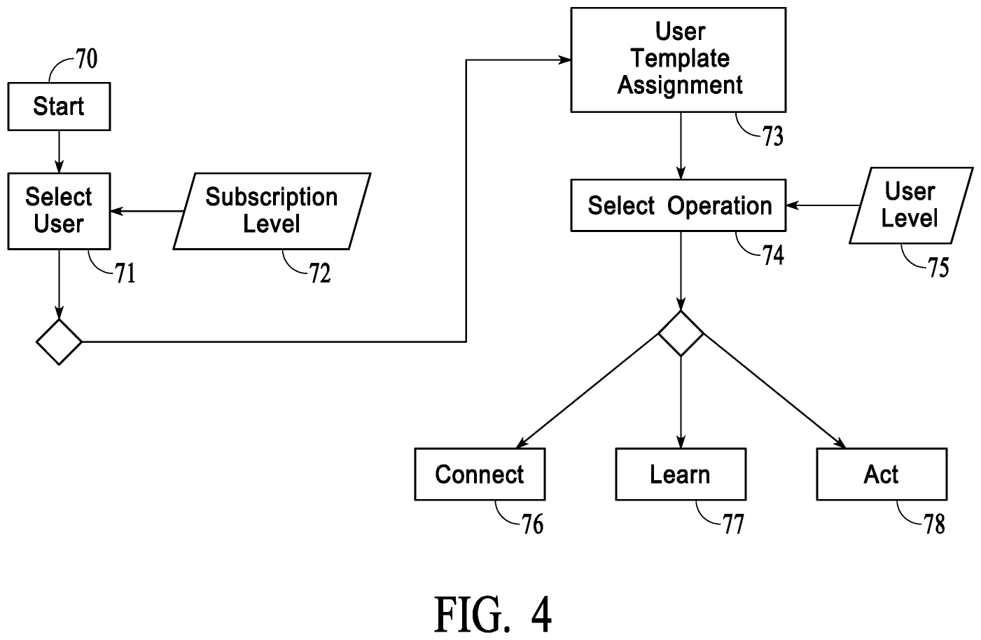

FIG. 4 illustrates how the template-based tool allows a user to become client, an agent, or an agency based on a commercialized value of subscription level. The template-based tool, through subscription, allows a user to utilize the features for the different user level. An agent can be a client. A client can be an agent. An agent can form an agency. The template-based tool utilizes a template approach and through the personalization allows the switching of usage when subscription requirements from each of the desired level has been met.

To ensure personalization can be managed and implemented efficiently, the template-based tool utilizes template approach which can be customized upon inputs and user characteristic. Templates for the template-based tool are built within a framework that allows multiple levels of architecture to address many issues while constraining itself, so implementation and maintainability are practical can be commercialized.

FIG. 4 is a simplified diagram illustrating selection of templates and operations by a user that is an agency, an agent or a client. In a block 70, a user accesses the template-based tool. In a block 71, the user identification is selected. A subscription level 72 is accessed to determine a user template assignment 73 as to whether the user is identified as a client, an agent or an agency. In a block 74, the user selects an operation. Allowed operations are determined by a user level 75. For example, a connect menu 76 for connection operations available from a connection template, a learn menu 77 for learning operations available from a learning template or an act menu 78 available from an action template for various potential actions is presented to the user based on the user selections.

The three types of implementation templates, learn (education) template, connect (communication/friends) template and act (execution) template are used by clients, agents and agencies, but within user-specific contexts and actions dependent upon the privileged granted to the user. The three template approach is implemented as common templates that can be personalized for any user, whether a client, an agent or an agency. Each type of users utilizes the template-based tool to learn, connect, and take actions through various forms. The template-based tool keeps tracks how the user obtains the template-based tool and the subscription level. Along with user characteristic and with this information, the template-based tool personalizes the template onto a targeted solution.

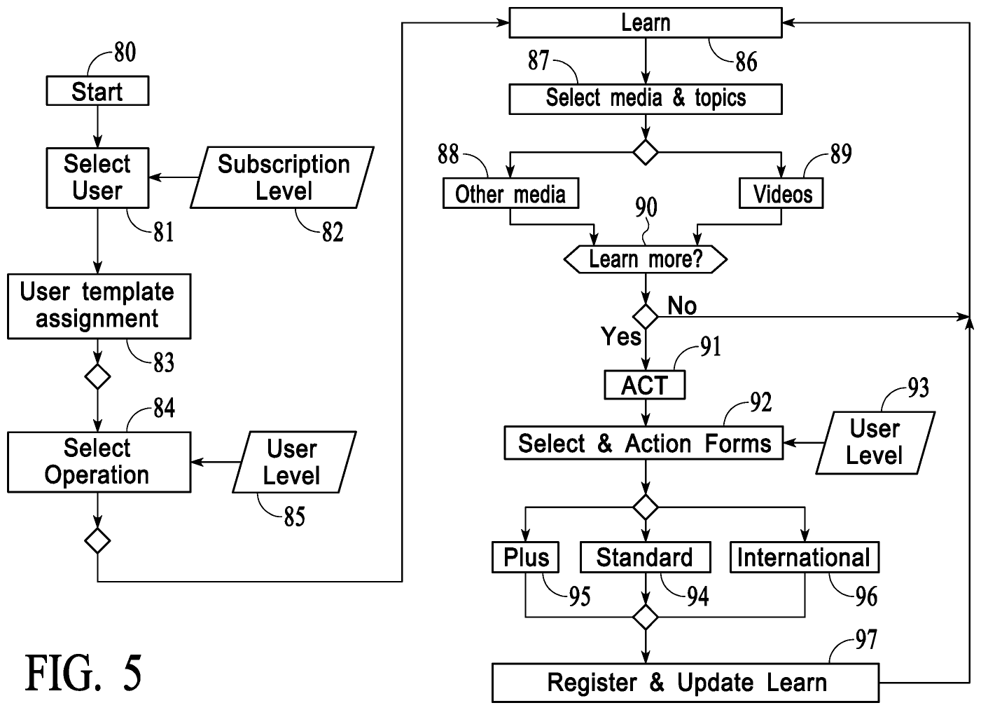

FIG. 5 is a simplified diagram illustrating selection of a learn template by a user that is an agency, an agent or a client. In a block 80, a user accesses the template-based tool. In a block 81, the user identification is selected. A subscription level 82 is accessed to determine a user template assignment 83 as to whether the user is identified as a client, an agent or an agency. In a block 84, the user selects an operation. Allowed operations are determined by a user level 85. A learn menu 86 allows a user to select media and topics in a block 87. For example, a user can select videos 89 or other media 88. After completion, a user is given the option to learn more in a block 90. If no, the user is returned to learn menu 86.

If yes, from block 90, the user proceeds to an act template 91. In a block 92, the use selects action forms. The various actions available are based on a user level 93. For example, the user can select from a standard collection 94, a plus collection 95 or an international collection 96. In a block 97, the user can register, update information and learn.

FIG. 5 illustrates how educational contexts are passed to the user. Specific contents can be passed along cross functionally between the client, an agent and an agency. As a client, the user acquires information through slides or videos. The delivered slides or videos can be personalized for each user and based on how different groups of users interact with each other. For example, a 30-year old client may receive informational content that is relevant to his or her age range or situation. The personalized information can be tailored by an agent through various customized templates. A user who is an agent can learn through customized templates that are created by the agency. The learn template is also a place where a user can upload their specific context that they want to deliver to another user. The learn template is where a user can be educated and educate others. The learn template also implements internationalization features so the template-based tool can be used globally.

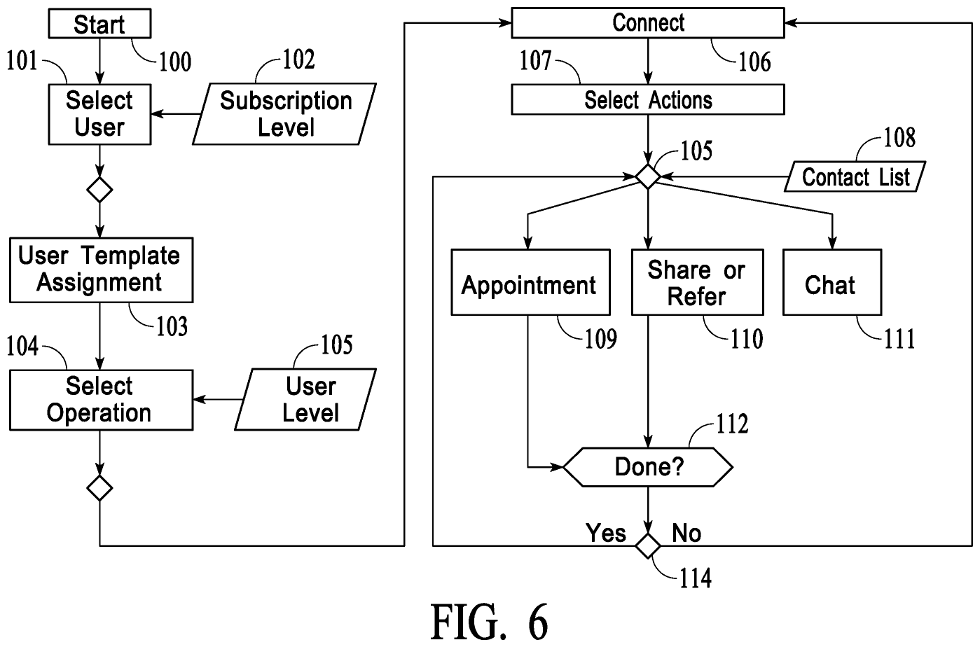

FIG. 6 is a simplified diagram illustrating selection of a connect template by a user that is an agency, an agent or a client. In a block 100, a user accesses the template-based tool. In a block 101, the user identification is selected. A subscription level 102 is accessed to determine a user template assignment 103 as to whether the user is identified as a client, an agent or an agency. In a block 104, the user selects an operation. Allowed operations are determined by a user level 105. A connect menu 106 allows a user to select actions in a block 107. The actions are performed based on a contact list 108, listing possible contacts. Selected actions can include, for example, an appointment 109 with a contact, a share with or refer to a contact, in a block 110 or a chat 111. In a block 112, the user selects if they are done with contacts. From a decision point 114, a no decision results in a return to connect menu 106. From decision point 114, a yes decision results in a return to select decision point 115.

The connect template allows users to connect with each other, share and refer content and contacts. As a client, a user can connect to an agent, share or refer content between other clients and agents. Referral features available under the connect template allows users to pass and share information about educational content as well as agent information that may help other user to achieve their goals.

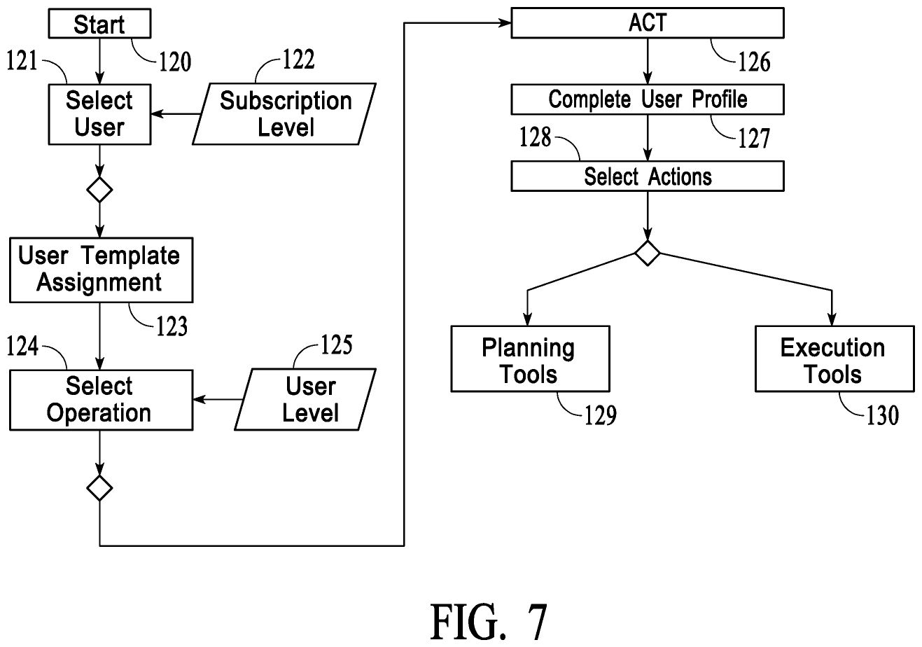

FIG. 7 is a simplified diagram illustrating selection of an act template by a user that is an agency, an agent or a client. In a block 120, a user accesses the template-based tool. In a block 121, the user identification is selected. A subscription level 122 is accessed to determine a user template assignment 123 as to whether the user is identified as a client, an agent or an agency. In a block 124, the user selects an operation. Allowed operations are determined by a user level 125. An act menu 126 allows a user to complete a user profile 127. Act menu 126 also allows a user to select action tools in a block 187. Selected actions can include, for example planning tools 129 and execution tools 130.

The act template allows the user to act upon what has been learned and shared with friends. Form templates are invention's representation to aid user turning what has been learned and communicated into actions. The act template realizes this action by applying automatic programming technology to automatically fill up forms and drive actions, such as clicking buttons or advancing to a different web site or forms.

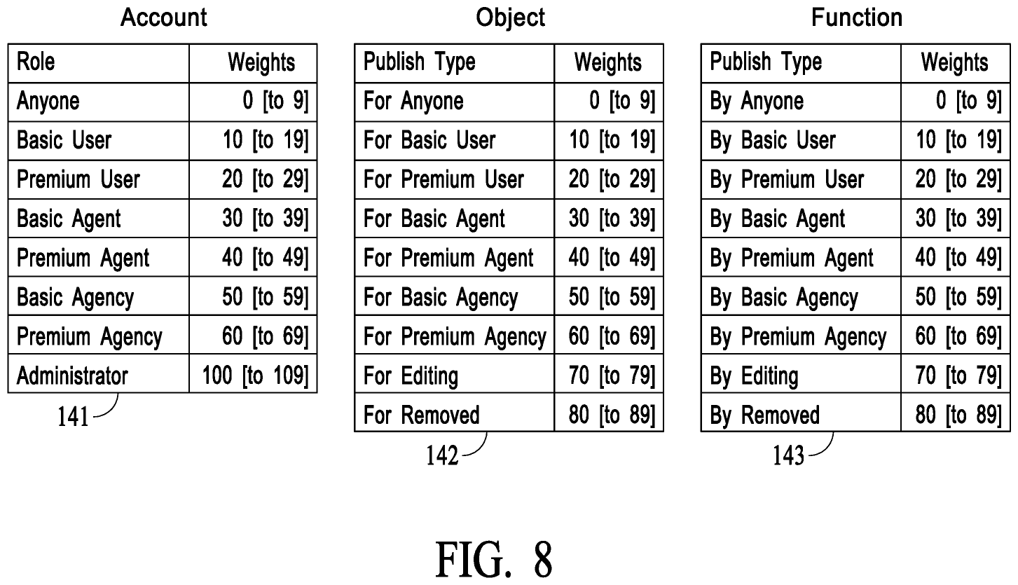

FIG. 8 illustrates use of ledger weights to distinguish accounts, objects and functions for an agency, an agent or a client. For each category, a default weight is assigned. Weight categorization can be expanded for further access distinctions and further feature expansion. For example, the weight assigned to each user is dependent on the subscription level for the user.

Table 141, stored in database 41, shown in FIG. 2, illustrates weights stored for each user that indicate their role within an agency. For example, a weight of 0 to 9 indicates that there is no role assigned yet to the user. For example, the default weight is 0. A weight of 10 to 19 indicates that the user is a client that is a basic user. For example, the default weight is 10. A weight of 20 to 29 indicates that the user is a client that is a premium user. For example, the default weight is 20. Basic users and premium users are both considered to be clients. A client is a client for a specific agent within a specific agency.

A weight of 30 to 39 indicates that the user is a basic agent. For example, the default weight is 30. A weight of 40 to 49 indicates that the user is a premium agent. For example, the default weight is 40. A weight of 50 to 59 indicates that the user is a basic agency. For example, the default weight is 50. A weight of 60 to 69 indicates that the user is a premium agency. For example, the default weight is 60. A weight of 100 to 109 indicates that the user is an administrator. For example, the default weight is 100. In general, when a user visits the website or the application, a weight is assigned at the point of visitation and creation. Users with more privileges will be at a heavier weight.

Table 142, shown in FIG. 8, is stored in database 41, which is shown in FIG. 2. Table 142 illustrates weights stored for each object that indicates who has access to the object. For example, a weight of 0 to 9 indicates that there is no restriction on use of the object—any user can use the object. A weight of 10 to 19 indicates that a basic user and users with higher weight can use the object. A weight of 20 to 29 indicates that a premium user and users with higher weight can use the object. A weight of 30 to 39 indicates that a basic agent and users with higher weight can use the object. A weight of 40 to 49 indicates that a premium agent and users with higher weight can use the object. A weight of 50 to 59 indicates that a basic agency and users with higher weight can use the object. A weight of 60 to 69 indicates that a premium agency and users with higher weight can use the object. A weight of 100 to 109 indicates that an administrator can use the object. In general, when an object is created, the object will have a weight assigned that is based on the targeted user of the object. The weight can be assigned, for example, by the agency or an administrator.

Table 143, shown in FIG. 8, is stored in database 41, which is shown in FIG. 2. Table 143 illustrates weights stored for each executable function that indicates who is privilege to execute the function. For example, a weight of 0 to 9 indicates that there is no restriction on who can execute the function—any user can execute the function. A weight of 10 to 19 indicates that a basic user and users with higher weight can execute the function. A weight of 20 to 29 indicates that a premium user and users with higher weight can execute the function. A weight of 30 to 39 indicates that basic and users with higher weight can execute the function. A weight of 40 to 49 indicates that a premium agent and users with higher weight can execute the function. A weight of 50 to 59 indicates that a basic agency and users with higher weight can execute the function. A weight of 60 to 69 indicates that a premium agency and users with higher weight can execute the function. A weight of 70 to 79 indicates that users with editing privilege and users with higher weight can execute the function. A weight of 80 to 89 indicates that users with removing privilege and users with higher weight can execute the function. In general, when a function is created, the function will have a weight assigned that is based on the targeted user of the function. The weight can be assigned, for example, by the agency or an administrator.

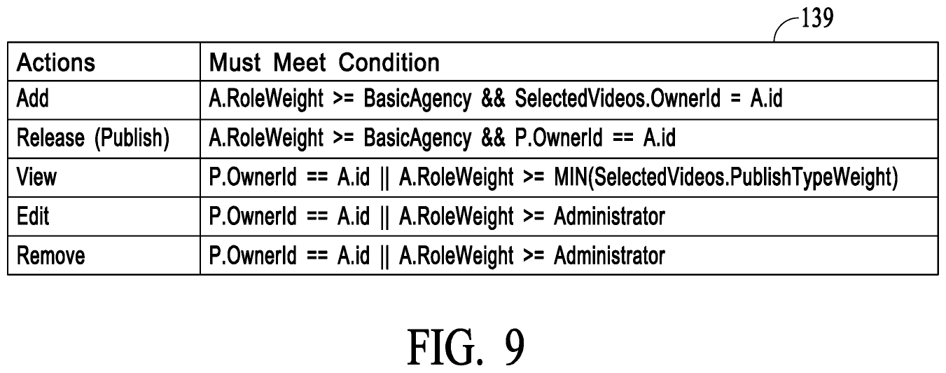

FIG. 9 shows a table 139 used to illustrates use of ledger weights to distinguish accounts, objects and functions for an agency, an agent or a client. As illustrated by table 139, object or functions weights are compared to an account weight assigned to a user to program control and accessibility for the user. For example, the comparison {account(A) weight} “>=” {object or function weights} indicates a condition under which accessibility and controllability is granted to a user account A for a user. In table 139, “A” is an abbreviation for “Current Account” of a user. “P” is an abbreviation for “a playlist object” accessed by a user. “Selected Videos” indicates videos in a playlist selected by the user.

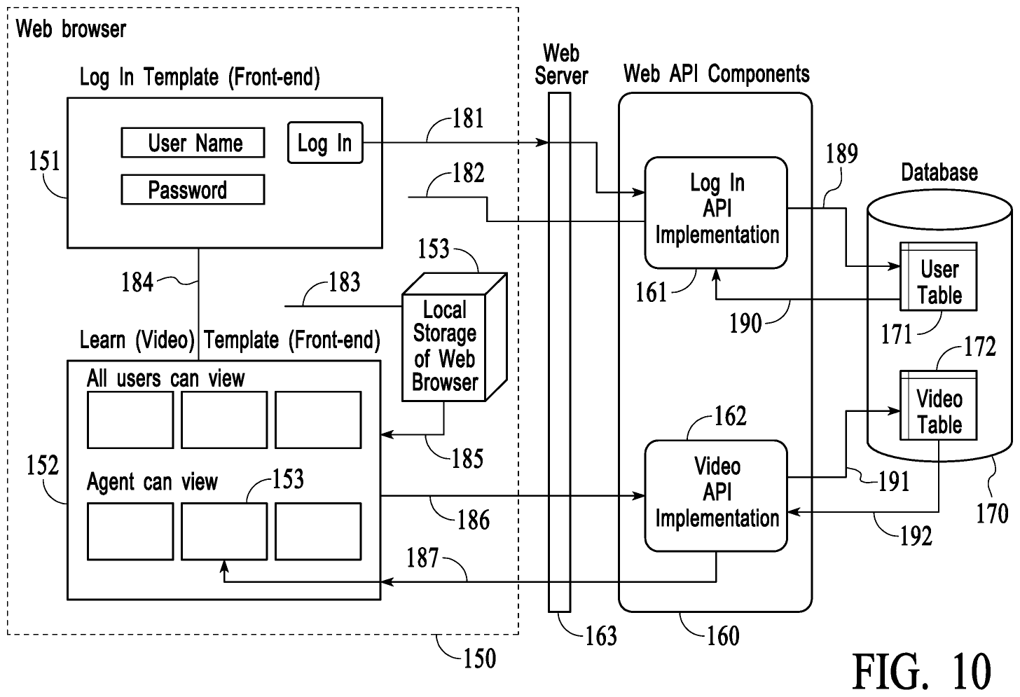

FIG. 10 is a simplified block diagram that illustrates interactions between a web browser a web server, web API components and a database when implementing connections with an agency, an agent or a client.

For example, as represented by an arrow 181, a user utilizes a log-in template 151 displayed by a web browser 150 to invoke a call login API sent through a web server 163 to a login API implementation 161 within web API components 160. As represented by an arrow 189, login API implementation 161 accesses a user table 171 within a database 170 to make a check to confirm a valid date user credential has been received from a log-in template 151. As represented by an arrow 190, if a valid date user credential has been received, user table 171 returns to login API implementation 161 a get user profile communication that includes a role number. As represented by an arrow 182, login API implementation 161 returns an identification token to login template 151. As represented by an arrow 183, login template 151 stores the identification token within local storage 153 of web browser 150.

As represented by an arrow 184, login template 151 redirects a user to a learn template front-end 152 for videos. As represented by an arrow 185, token login API implementation 161 accesses local storage 153 to retrieve the identification token for the user stored within local storage 153. As illustrated by an arrow 186, learn template front-end 152 sends to a video API implementation 162 within Web API components 161. As represented by an arrow 191, video API implementation 162 uses the token to access a video table 172 within database 170 in order to fetch related videos for the account of the user. As represented by an arrow 192, video table 11 returns to video API implementation 162 a list of videos that are available for viewing by the user. As represented by an arrow 186, video API implementation 162 sends the list of videos that are available for viewing by the user to video table 172. As represented by an arrow 187, video table 172 returns to learn template front-end 152 the list of videos that are available for viewing by the user.

Learn template front-end 152 displays to the user the list of videos that are available for viewing. For example, the list of videos includes graphics for each item in the list. For example, the list of videos that are available for viewing are displayed organized based on the user privilege. For example if the user is a basic agent, the display of the available videos are organized based on one category of videos clients are privileged to view and one category including additional videos agents are privileged to view. For example, there may be different categories for one or more of basic users, premier users, basic agents, premier agents, agencies and administrators.

For example, the forms provided to a user depend on a weight assigned to the user within user table 171. For example, available connection paths between users depend on the weight assigned to each user.

Since other modifications and changes varied to fit operating requirements and environments will be apparent to those skilled in the art, the template-based tool is not considered limited to the example chosen for purposes of disclosure and covers all changes and modifications which do not constitute departures from the true spirit and scope of this invention.

The template tool allows different agencies to connect with each other. This is accomplished through customizable standard templates that allow interaction expansion between agencies and through the connection template where agencies create the framework needed in communication between agencies.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A personalized template-based system, comprising:
a database that includes a user table, the user table assigning a weight to a user, the weight indicating whether the user is a client, an agent or an agency;
web application program interface (API) that includes:
a login application implementation that upon login by a user returns a token to the user that identifies the user, and
an API implementation block used to obtain information from the database; and
template tools that utilize the token when the user obtains the information from the database, the template tools, including:
a learn template that the user uses to access learning information from the database, the learning information being available from the interface to the user depending upon the weight assigned to the user,
a connect template that allows the user to communicate with other users, and
an act template that provides forms through which the user can perform actions.

2. A personalized template-based system as in claim 1, wherein the weight assigned to the user depends on a subscription level of the user.

3. A personalized template-based system as in claim 1, wherein the forms provided to the user depend on the weight assigned to the user.

4. A personalized template-based system as in claim 1, wherein connection paths to the other users depend on the weight assigned to the user.

5. A personalized template-based system as in claim 1, wherein within the user table, a different weight is assigned to the user depending on whether a subscription level for the user indicates the user is a client that is a basic user or a premium user.

6. A personalized template-based system as in claim 1, wherein within the user table, a different weight is assigned to the user depending on whether a subscription level for the user indicates the user is a basic agent or a premium agent.

7. A personalized template-based system as in claim 1, wherein within the user table, a different weight is assigned to the user depending on whether a subscription level for the user indicates the user is a basic agency or a premium agency.

8. A personalized template-based system as in claim 1, wherein the template tools allows the user to send a referral invitation to a potential user.

9. A personalized template-based system as in claim 8, wherein the database additionally includes an interaction information table that records information about the user, the potential user and the referral invitation.

10. A personalized template-based system as in claim 1, wherein the database additionally includes transaction ledger that records transactions by the user.

11. A computer implemented method, comprising:
storing a user table in a database, the user table assigning a weight to a user, the weight indicating whether the user is a client, an agent or an agency;
upon login by a user, returning by a login application implementation to the user, a token that identifies the user;
utilizing the token when the user obtains the information from the database, wherein the API implementation block is used to obtain information from the database;
using a learn template to access learning information from the database, the learning information available from the interface to the user depending upon the weight assigned to the user;
using a connect template to allow the user to communicate with other users; and
using an act template that provides forms through which the user can perform actions.

12. A computer implemented method as in claim 11, wherein the weight assigned to the user depends on a subscription level of the user.

13. A computer implemented method as in claim 11, wherein the forms provided to the user depend on the weight assigned to the user.

14. A computer implemented method as in claim 11, wherein connection paths to the other users depend on the weight assigned to the user.

15. A computer implemented method as in claim 11, wherein within the user table, a different weight is assigned to the user depending on whether a subscription level for the user indicates the user is a client that is a basic user or a premium user.

16. A computer implemented method as in claim 11, wherein within the user table, a different weight is assigned to the user depending on whether a subscription level for the user indicates the user is a basic agent or a premium agent.

17. A computer implemented method as in claim 11, wherein within the user table, a different weight is assigned to the user depending on whether a subscription level for the user indicates the user is a basic agency or a premium agency.

18. A computer implemented method as in claim 11, wherein the template tools allows the user to send a referral invitation to a potential user.

19. A computer implemented method as in claim 18, wherein the database additionally includes an interaction information table that records information about the user, the potential user and the referral invitation.

20. A computer implemented method as in claim 11, wherein the database additionally includes a transaction ledger that records transactions by the user.
